(19) United States
(12) Patent Application Publication
(10) Pub. No.: US 2009/0153814 A1
(43) Pub. Date: Jun. 18, 2009

(54) SELF-CLEANING SCAN HEAD ASSEMBLY

(76) Inventors: Charles B. Langrel, Lexington, KY (US); Chongwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/954,865

(22) Filed: Dec. 12, 2007

(51) Int. Cl. G03B 27/52

(52) U.S. Cl. 355/30

(57) ABSTRACT

A scan head assembly for use in an imaging device for scanning media that uses fluid particles from the atmosphere for cooling an optical system, cleaning existing contamination particles in the scan head assembly and preventing contamination particles from accruing in the scan head assembly. The scan head assembly is enclosed in a chamber housing having an inlet in fluid communication with the scan head assembly and atmosphere. The scan head assembly has an optical system and a cooling mechanism located adjacent to the inlet. During use, the cooling mechanism directs fluid particles from the atmosphere through the inlet across the scan head assembly to provide cooling and cleaning to the scan head assembly, including the optical system. A negative pressure system is created within the scan head assembly to prevent contamination particles from accruing in the optical system.

### TECHNICAL FIELD

The present invention relates generally to scan head assemblies for use in imaging devices, such as printers, multi-function printers (MFP's), all-in-ones, fax machines, copiers and scanners. In particular, it relates to a scan head assembly for use in an imaging device for scanning media that uses a cooling mechanism, such as a fan to simultaneously cool an optical system located within the scan head assembly and remove contamination particles from the scan head assembly.

### BACKGROUND OF THE INVENTION

An imaging device for scanning media is a device that optically scans images, text and the like from documents and other media and converts it to a digital image that can be replicated. Imaging devices for scanning media can perform duplex document scanning, which involves scanning both sides of a media and/or simplex document scanning wherein only one side of the media is scanned (usually a front side of the media).

Generally, there are two types of imaging devices for scanning media. The first type uses a single scan head assembly. The single scan head assembly is shared by both a flatbed scanner and an automatic document feeder (ADF). The flatbed scanner is usually composed of a transparent flat platen, which is used to receive the media being scanned. Under the platen is a light source, such as a xenon lamp, to illuminate the media being scanned. Further, the flatbed scanner has mirrors to direct reflected light from the media to an image sensor, such as a charge-coupled device (CCD) module to capture the image via a lens to focus the light. The single scan head assembly can be used for duplex document scanning wherein a recirculating media feed path is used, so both sides of the media are scanned or simplex document scanning wherein a direct single pass feed path is used.

The second type of imaging device for scanning media uses a direct single pass media feed path with two scan head assemblies located on each side of the media feed path. In this arrangement, a first scan head assembly is shared by the flatbed scanner and the ADF for scanning the top or “face-up” side of the media. The first scan head assembly typically located below the media feed path is similar to the single scan head assembly discussed above for the flatbed scanner. Further, a second scan head assembly typically located above the media feed path is used for scanning the bottom or “backside” of the media. The second scan head assembly or “backside” scan head assembly has similar components as the first scan head assembly, such as a light source, mirrors, CCD module and lens. Instead of having a platen at a top surface of the scan head assembly, a transparent plate made of glass or other similar rigid material is located at a bottom part of the second scan head assembly.

In both types of imaging devices for scanning media, operating temperature control and contamination control are two primary issues governing the design of the device. Generally, the temperature of an optical system located in the scan head assembly is relatively high because high intensity illumination is needed to meet the speed requirement of the imaging device. As a result, a cooling mechanism to control temperature under adequate operating temperature, which is usually required to be less than fifty degrees Celsius (50° C.) should be provided. Moreover, the scan head assembly should be configured to clean and prevent contamination within the optical system, which causes image quality issues including artifacts and overall stray light induced quality issues.

The traditional approach to prevent contamination in the scan head assembly is to eliminate openings within the scan head assembly, including the optical system and provide a clean environment for the optical system to operate. As a result, the scan head assembly is a closed or sealed system, which prevents contamination particles from entering into the optical system. Although a closed scan head assembly is simple and economically feasible for low temperature imaging devices for scanning media, it is not as effective for imaging devices using a high intensity light source to meet the need for higher scan speed because it is difficult to cool the optical system. Moreover, it is nearly impossible to prevent contamination particles from accumulating in the scan head assembly even with a closed system. Even if the scan head assembly was assembled under ideal conditions, aging and vibration creates contamination particles. Further, the media travels along the media feed path through the ADF making it difficult to prevent contamination particles from entering the scan head assembly.

An alternative to the closed scan head assembly, is to use a fan in the scan head assembly to cool the optical system. Typically, the fan is orientated within the scan head assembly to transfer air from inside the scan head assembly to the outside. In this arrangement, it is necessary to have a dedicated inlet and exhaust for the scan head assembly. However, since the scan head assembly is not a closed system due to the dedicated inlet and exhaust, contamination particles are more prevalent in this system. As a result of contamination particles existing in the optical system, the quality of the scanned image decreases, such as false vertical lines in the scanned image.

Accordingly, the art of imaging devices for scanning media has a need for a scan head assembly that allows effective cooling of the optical system while preventing contamination particles from accruing in the scan head assembly and cleaning existing contamination particles in the scan head assembly.

### SUMMARY OF THE INVENTION

The above-mentioned and other problems become solved by applying the principles and teachings associated with the hereinafter described self-cleaning scan head assembly.

In a basic sense, an imaging device for scanning media has a first chamber housing enclosing a first scan head assembly in a location below a media feed path. The first scan head assembly has a first optical system having a light source to illuminate a media being scanned and a charged-coupled device (CCD) module to capture the image via a lens from the media. Preferably, the first optical system is cooled to prevent thermal damage. Further, the first scan head assembly, including the first optical system must be free from any contamination to prevent any blocking of the optical path, which decreases quality in the scanned image. As a result, it is necessary to provide the first scan head assembly with effective cooling and cleaning.

In one embodiment, the invention teaches the first chamber housing enclosing the first scan head assembly having a first inlet, such as an air vent in fluid communication with the first scan head assembly and atmosphere. The first scan head assembly has the first optical system and a first cooling mechanism, such as a fan located adjacent to the first inlet. During use, the first cooling mechanism directs fluid particles, such as air, from the atmosphere through the first inlet across the first scan head assembly to provide cooling and cleaning to the first scan head assembly, including the first optical system. Further, the first scan head assembly may have a filter located between the first inlet and the first cooling mechanism. The filter is configured to prevent fluid particles of a certain size in the atmosphere from entering the first scan head assembly.

In other aspects of the invention, a second chamber housing enclosing a second scan head assembly in a location above the media feed path is disclosed. Further, the second chamber housing has a second inlet such as an air vent in fluid communication with the second scan head assembly and atmosphere. The second scan head assembly has a second optical system and a second cooling mechanism located adjacent to the second inlet. Further, the second scan head assembly may have a duct located adjacent to the second cooling mechanism. During use, the second cooling mechanism directs fluid particles from the atmosphere through the second inlet, then through the duct and across the second scan head assembly to provide cooling and cleaning to the second scan head assembly, including the second optical system.

These and other embodiments, aspects, advantages, and features of the present invention will be set forth in the description which follows, and in part will become apparent to those of ordinary skill in the art by reference to the following description of exemplary embodiments of the invention and referenced drawings or by practice of the invention. The aspects, advantages, and features of the invention are realized and attained according to the following description and as particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a perspective view in accordance with one embodiment of this invention of an exemplary imaging system;

FIG. 2 is a perspective view in accordance with one embodiment of this invention of a first scan head assembly;

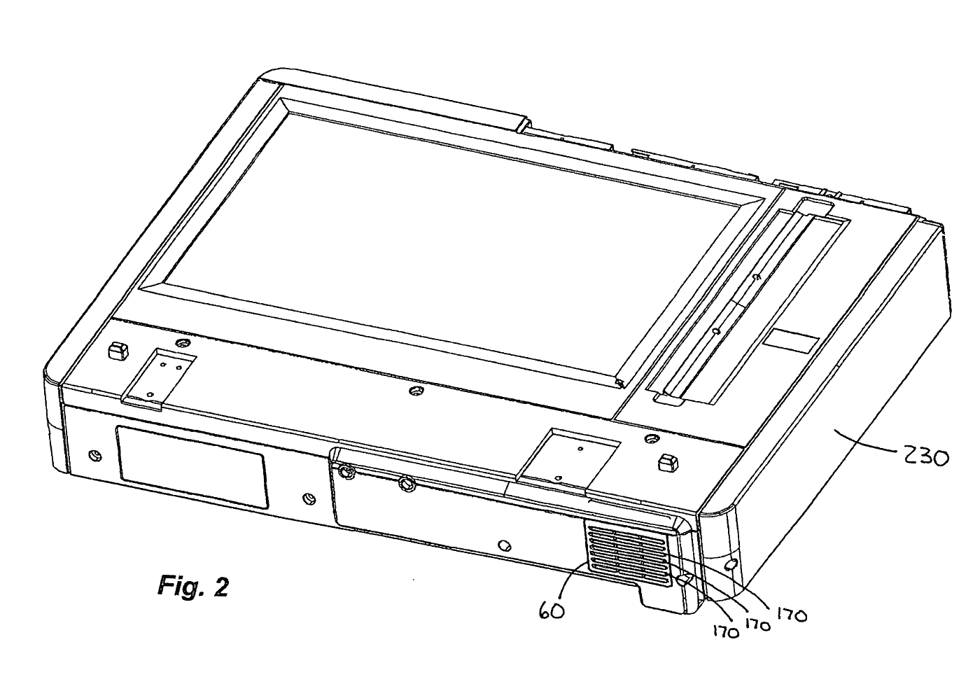

FIG. 3 is a perspective view in accordance with one embodiment of this invention of an interior of the first scan head assembly;

FIG. 4 is a partial top view in accordance with one embodiment of this invention of the interior of the first scan head assembly;

FIG. 5 is a partial side view in accordance with one embodiment of this invention of the interior of the first scan head assembly;

FIG. 6 is a top isometric view in accordance with one embodiment of this invention of a second scan head assembly; and

FIG. 7 is a bottom isometric view in accordance with one embodiment of this invention of the second scan head assembly.

### DETAILED DESCRIPTION OF THE DRAWINGS

In the following detailed description of the drawings, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process or other changes may be made without departing from the scope of the present invention. The following detailed description is, therefore, not to be taken in a limiting sense, and the scope of the present invention is defined only by the appended claims and their equivalents. In accordance with the present invention, a self-cleaning scan head assembly is hereinafter described.

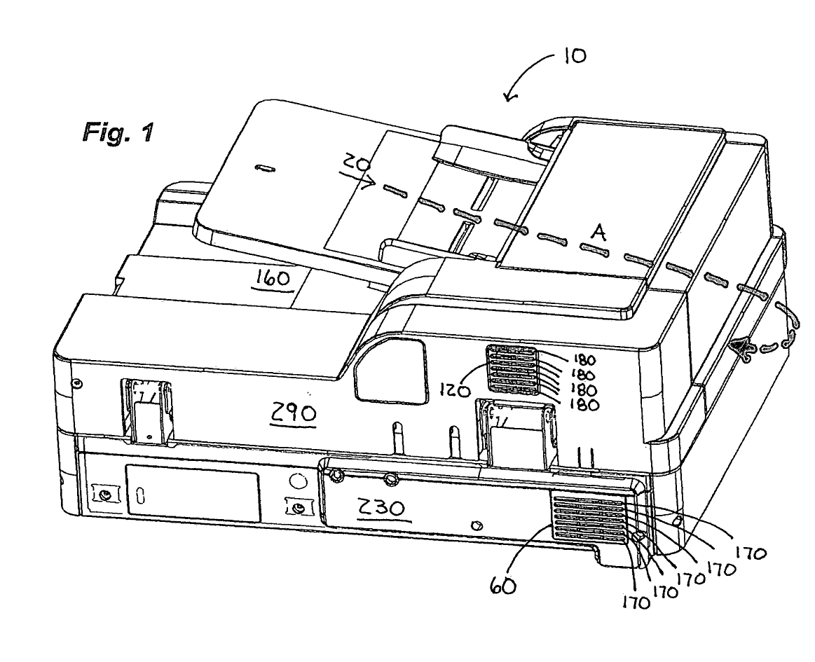

With reference to FIG. 1, an imaging device 10 for scanning media is shown. The imaging device 10 has a media feed path 20, which is substantially C-shaped (indicated by the dashed-lined arrow A), proceeding between a first housing chamber 230 enclosing a first scan head assembly 30 and a second housing chamber 290 enclosing a second scan head assembly 90 and ending in a media feed tray 160. The first chamber housing 230 having a first dedicated inlet 60 is located below the media feed path 20. The first scan head assembly 30 contained within the first chamber housing 230 is used for scanning a top side of the media.

In one embodiment, the first inlet 60 is an air vent, which is substantially rectangular with a plurality of parallel slots 170 exposed to the atmosphere to allow fluid particles from the atmosphere to enter the first scan head assembly 30. The second chamber housing 290 having a second dedicated inlet 120 is located above the media feed path 20. The second scan head assembly 90 contained within the second chamber housing 290 is used for scanning a back side of the media. The second inlet 120 is also in the form of an air vent, which is substantially square-shaped with a plurality of parallel slots 180 exposed to the atmosphere to allow fluid particles from the atmosphere to enter the second scan head assembly 90.

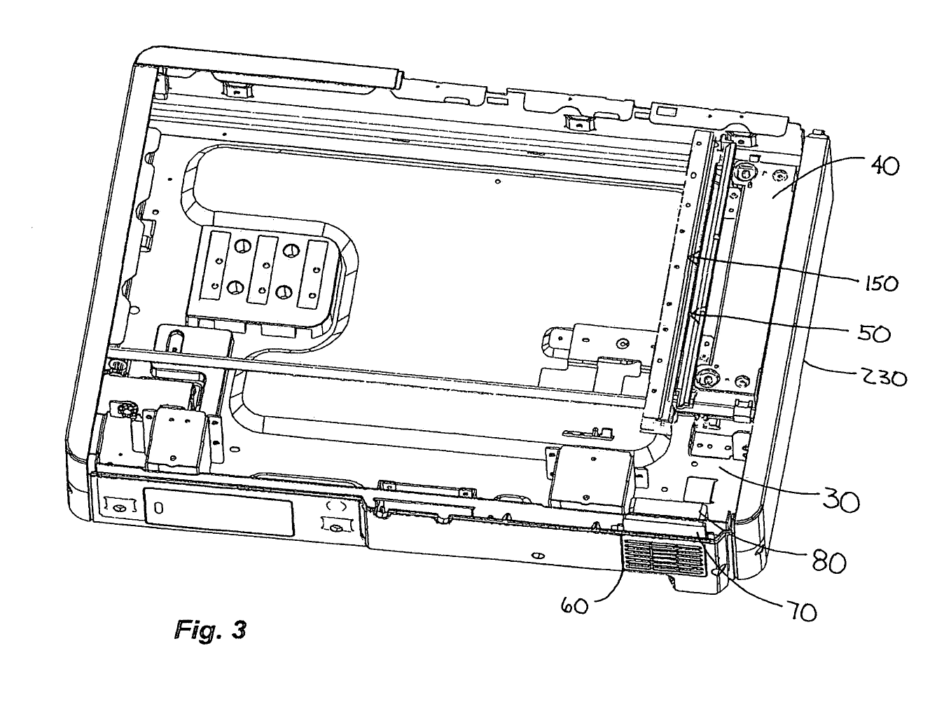

Turning to FIG. 3, the first chamber housing 230 encloses the first scan head assembly 30. The first scan head assembly 30 has a first optical system 40, a first cooling mechanism 80 and a filter 70. The first inlet 60 is in fluid communication with the first scan head assembly 30, including the first optical system 40 and atmosphere. The first cooling mechanism 80 is located adjacent to the first inlet 60. The filter 70 is located between the first inlet 60 and the first cooling mechanism 80 to prevent fluid particles of a certain size in the atmosphere from entering the first scan head assembly 30.

The first optical system 40 of the first scan head assembly 30 is of a kind generally known in the art. Skilled artisans will appreciate that it has a light source 150 to illuminate a media being scanned and a CCD module (not shown) to capture the image via a lens (not shown) from the media. During use, the first cooling mechanism 80, such as a fan, directs fluid particles from the atmosphere through the first inlet 60 across the first scan head assembly 30 to provide cooling and cleaning to the first scan head assembly 30, including the first optical system 40. Further, the first scan head assembly 30 has at least one opening 50 positioned above the light source 150 of the first optical system 40 such that a negative pressure system exists to prevent contamination from accruing in the first scan head assembly 30, including the first optical system 40.

This invention offers a number of advantages not disclosed in the prior art. Specifically, the scan head assembly is designed to provide effective cooling to the optical system while using the same air flow for cooling to clean the scan head assembly, including the optical system. The cooling mechanism, such as a fan introduces filtered fluid particles through the dedicated inlet of the chamber housing. Since the chamber housing enclosing the scan head assembly is not completely sealed, the air pressure within the chamber housing increases until it escapes through a plurality of openings in the chamber housing. Air is pushed through the plurality of openings of the housing chamber, which creates a positive air pressure system to prevent unfiltered fluid particles from entering the scan head assembly from any of the plurality of openings in the chamber housing (fluid particles may only enter the scan head assembly through the dedicated inlet) while allowing contamination particles to exit the scan head assembly.

Additionally, a negative air pressure system is created to prevent contamination particles from depositing in the scan head assembly, including within the optical system. To create the negative air pressure system when the cooling fluid particles pass through the scan head assembly, the scan head assembly is adequately sealed except for the at least opening facing the airflow. As the airflow from the fan pass over the at least one opening in the top of the mainly sealed scan head assembly, it creates a negative air pressure system at this point to pull the contamination particles away from the optical system. Moreover, the airflow passing through the scan head assembly helps prevent any depositing of contamination particles in the scan head assembly, including the optical system.

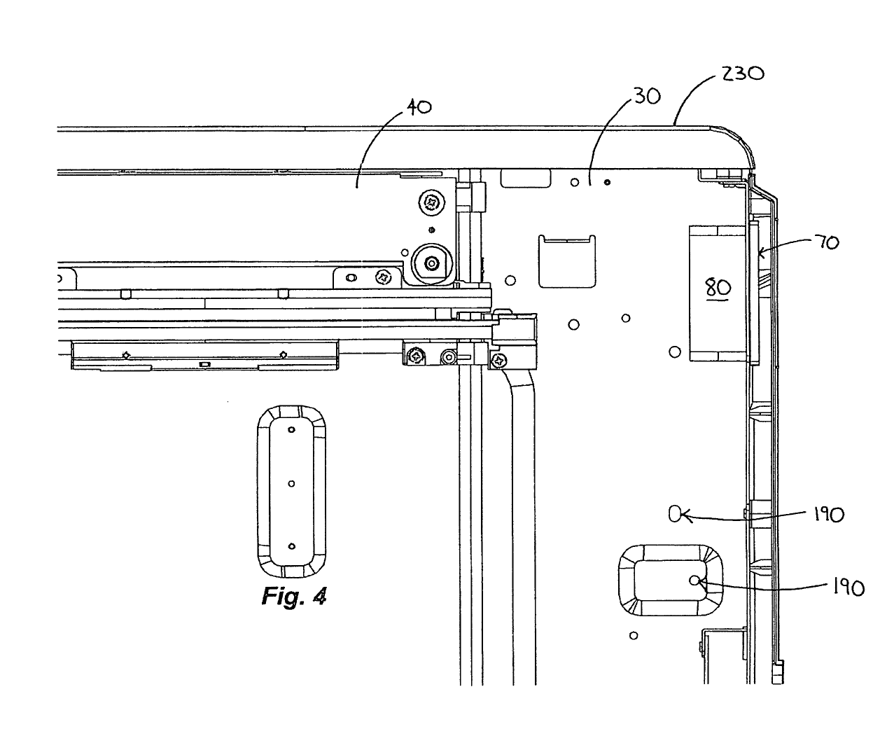

Turning to FIGS. 3-5, the first cooling mechanism 80 is located adjacent to the first inlet. 60. The first cooling mechanism is a fan, such as the INTERFAN® PO012-12D-2B-2. The INTERFAN® model is 60 mm×60 mm×25 mm and capable of producing airflow of 12 cubic feet per minute (CFM). The size and type of fan used will depend on a number of factors, such as the size and speed of the imaging device. The fan is made of reinforced plastic and has sealed ball bearings.

The first cooling mechanism 80 directs fluid particles from the atmosphere through the first inlet 60 into the first scan head assembly 30 to the first optical system 40. The first cooling mechanism 80 is able to direct fluid particles from the atmosphere into the first scan head assembly 30 pursuant to Bernoulli's principle. Bernoulli's principles provides that for an ideal fluid, an increase in velocity occurs simultaneously with a decrease in pressure. Accordingly, velocity and pressure are inversely related. Further, it is well known that fluid particles, such as air, move from high pressure to low pressure. During use, the fan creates an increase in velocity (and a corresponding decrease in pressure) at the first inlet 60 and, therefore, fluid particles from the atmosphere enter the first scan head assembly 30 through the first inlet 60.

The first scan head assembly 30 also has a filter 70 located between the first inlet 60 and the first cooling mechanism 80 to control the size of fluid particles entering the first scan head assembly 30. The filter 70 is configured to prevent fluid particles of a certain size in the atmosphere from entering the scan head assembly 30 through the first inlet 60. The filter 70 may be designed in variable densities depending on the fluid particle removal efficiency necessary in the first scan head assembly 30. Specifically, the filter 70 may be designed to block particles in the micron size range, but still provide sufficient airflow to cool and clean the first scan head assembly, including the first optical system 40. The filter 70 is made of a foam porous material.

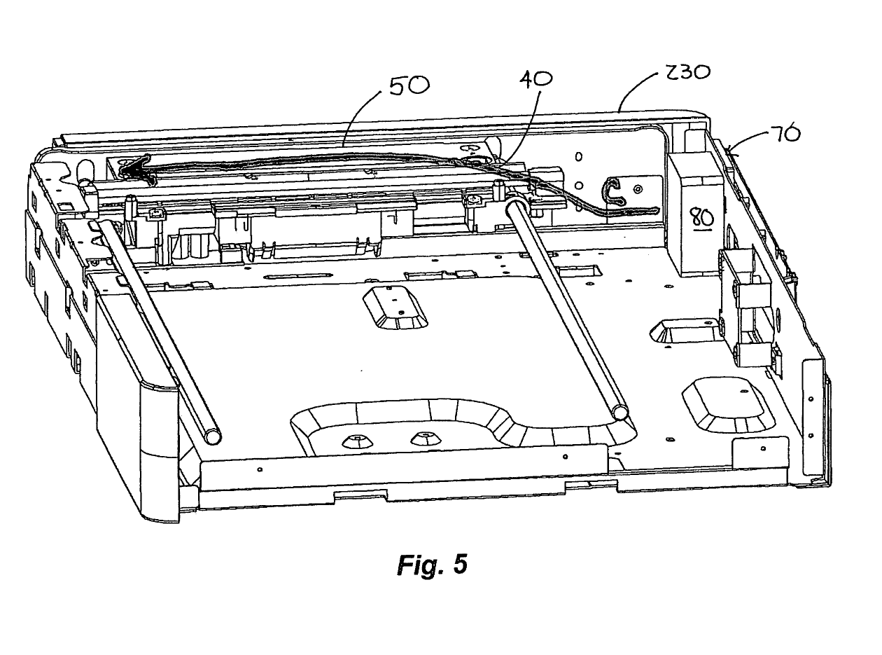

As shown in FIG. 5, the first cooling mechanism 80 directs air flow along direction arrow C to the first optical system 40 across the light source 150 and the at least one opening 50 in the first scan head assembly 30. Since the first optical system 40 is sealed except for the at least one opening 50 in a top portion of the scan head assembly 30, moving the air flow above the first optical system 40 effectively creates a negative air pressure system in the first scan head assembly 30. As a result, contamination particles are prevented from collecting on the critical optical system components (such as the mirrors and lens) of the first optical system 40. The air pressure within the first scan head assembly 30 increases until fluid particles escape through a plurality of openings 190 located in the first chamber housing 230. Accordingly, the airflow created by the first cooling mechanism 80 not only cools and cleans the first scan head assembly 30, but also provides negative air pressure to prevent contamination particles from collecting in the first optical system 40.

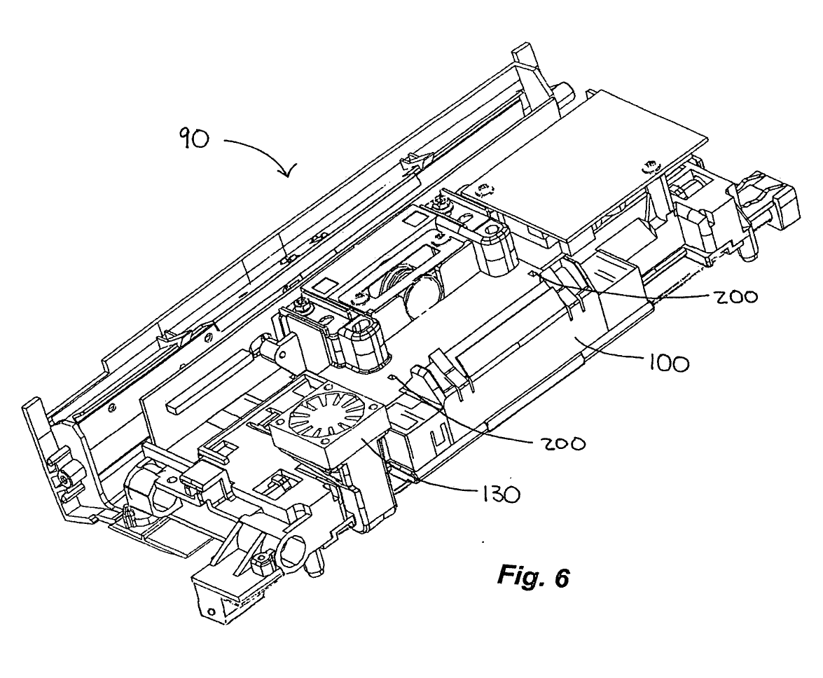

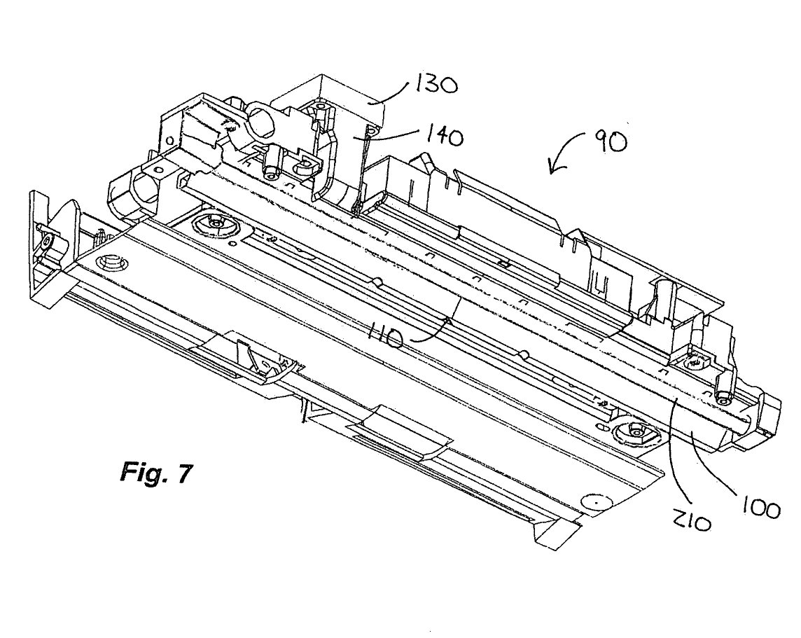

In another embodiment, a second housing chamber 290 enclosing a second scan head assembly 90 is disclosed as shown in FIGS. 6 and 7. The same principles discussed above can be applied to the second scan head assembly 90 for scanning the backside of the media. The second scan head assembly 90 has a second optical system 100. The second optical system 100 is of a kind generally known in the art. The second optical system has a second light source 180, which may be a xenon lamp or cold cathode fluorescent lamp.

The second scan head assembly 90 has a second cooling mechanism 130. The second cooling mechanism 130 is a fan, which may be of the type previously described. Again, the size and speed of the fan will depend upon various factors related to the type of imaging device used. The second cooling mechanism is located adjacent to the second inlet 120, such as an air vent. The second cooling mechanism 130 directs fluid particles from the atmosphere through the second inlet 120 into the second scan head assembly 90 to the second optical system 100. The second cooling mechanism 130 is able to direct fluid particles from the atmosphere into the second scan head assembly 90 pursuant to Bernoulli's principle as described above. The air pressure within the second scan head assembly 90 increases until fluid particles escape through another plurality of smaller openings 200 located in the second housing chamber 290.

The second optical system 100 including a second light source 210 are located below the second cooling mechanism 130. In order to direct fluid particles from the atmosphere to the second optical system 100, a duct 140 is positioned between the second cooling mechanism 130 and the second optical system 100. The duct 140 is substantially rectangular shaped and is in contact with the second cooling mechanism 130. The type of duct used will depend upon the corresponding type of fan used. As a result of this arrangement, the fluid particles are directed to the hottest component of the second optical system 100, the second light source 210, to effectively cool the second optical system 100 and to prevent contamination particles from collecting on the optics and glass surface of the second optical system 100. Due to the orientation of the second scan head assembly, gravity helps prevent contamination particles from floating upwards into the second optical system 100. Further, the airflow created by the second cooling mechanism 130 and the duct 140 create a negative air pressure system across the at least one opening 110 in the second scan head assembly 90 to further prevent contamination particles from collecting in the second optical system 100. The at least one opening 110 in the second scan head assembly is located below the second optical system 100.

In an alternative embodiment, the imaging device for scanning media may have a first scan head assembly located above the media feed path without a second scan head assembly located below the media feed path is contemplated. In this embodiment, the imaging device may perform duplex scanning wherein a recirculating media feed path is used to scan both sides of the media or simplex scanning wherein the media feed path is C-shaped and only the top-side of the media is scanned. In simplex scanning, the media being fed should be properly orientated so that the correct side of the media (i.e., the side having the image) is scanned as known in the art.

In addition, the imaging device for scanning media may also have a first scan head assembly located below the media feed path without a second scan head assembly located above the media feed path is contemplated. In this embodiment, the imaging device may perform duplex scanning wherein a recirculating media feed path is used to scan both sides of the media or simplex scanning wherein the media feed path is C-shaped and only the top-side of the media is scanned. In simplex scanning, the media being fed should be properly orientated so that the correct side of the media (i.e., the side having the image) is scanned as known in the art.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. An imaging device, comprising:
a media feed path; and
a chamber housing enclosing a scan head assembly for scanning media from a location above or below the media feed path, said chamber housing having an inlet in fluid communication with said scan head assembly and atmosphere, said scan head assembly having an optical system and a cooling mechanism located adjacent to said inlet wherein said cooling mechanism during use directs fluid particles from the atmosphere across said scan head assembly to provide cooling and cleaning to said optical system.

2. The imaging device of claim 1, wherein said cooling mechanism is a fan.

3. The imaging device of claim 1, wherein said scan head assembly further having a filter located between said inlet and said cooling mechanism.

4. The imaging device of claim 3, wherein said filter is configured to prevent fluid particles of a certain size in the atmosphere from entering said scan head assembly.

5. The imaging device of claim 3, wherein said filter is made of a foam porous material.

6. The imaging device of claim 1, wherein said scan head assembly further having a duct located between said cooling mechanism and said optical system.

7. The imaging device of claim 6, wherein said duct is configured to direct fluid particles from the atmosphere over said optical system.

8. The imaging device of claim 1, wherein said scan head assembly has at least one opening.

9. The imaging device of claim 8, wherein said optical system has a light source positioned below at least one opening in said scan head assembly such that during use contamination particles are prevented from accruing in said optical system.

10. An imaging device for scanning a media, comprising:
a media feed path;
a chamber housing enclosing a scan head assembly for scanning a front side of the media from a location below the media feed path, said chamber housing having an inlet in fluid communication with said scan head assembly and atmosphere, said scan head assembly having an optical system, a fan, and a filter located between said inlet and said fan, wherein said fan during use directs fluid particles from the atmosphere across said scan head assembly to provide cooling and cleaning to said scan head assembly; and
another chamber housing enclosing another scan head assembly for scanning a back side of the media from a location above the media feed path, said chamber housing having another inlet in fluid communication with said another scan head assembly and atmosphere, said another scan head assembly having another optical system, another fan located adjacent to said another inlet and a duct located adjacent to said another fan, wherein during use said another fan directs fluid particles from the atmosphere through said duct across said another scan head assembly to provide cooling and cleaning to said another scan head assembly.

11. The imaging device of claim 10, wherein said filter is configured to prevent fluid particles of a certain size in the atmosphere from entering said scan head assembly.

12. The imaging device of claim 10, wherein said duct is configured to direct fluid particles from the atmosphere across said another scan head assembly.

13. The imaging device of claim 10, wherein said scan head assembly has at least one opening positioned above said optical system such that during use contamination particles are prevented from accruing in said optical system.

14. The imaging device of claim 10, wherein said another scan head assembly has at least another opening positioned below said another optical system such that during use contamination particles are prevented from accruing in said another optical system.

15. A method for cleaning and cooling a scan head assembly having an optical system, comprising:
creating a fluid communication path between atmosphere and said scan head assembly through an inlet;
directing fluid particles from the atmosphere through said inlet across said scan head assembly;
cleaning said scan head assembly, including said optical system with fluid particles from the atmosphere; and
cooling said scan head assembly, including said optical system with fluid particles from the atmosphere.

16. The method of claim 15, wherein said creating further includes positioning a fan adjacent to said inlet to direct fluid particles from the atmosphere across said scan head assembly.

17. The method of claim 16, wherein said creating further includes positioning a filter between said inlet and said fan to prevent fluid particles of a certain size from entering said scan head assembly.

18. The method of claim 15, wherein said creating further includes positioning a duct adjacent to said fan to direct fluid particles across said scan head assembly.

19. The method of claim 15, further including preventing contamination from depositing in said scan head assembly.

20. The method of claim 19, wherein said preventing includes forming a negative pressure system around at least one opening in said scan head assembly to pull contamination particles away from said optical system.
